(19) United States
(12) Patent Application Publication
(10) Pub. No.: US 2002/0110104 A1
(43) Pub. Date: Aug. 15, 2002

(54) Hybrid media gateway control function providing circuit-switched access to a packet-switched radio telecommunications network

(75) Inventors: Sorin Surdila, St. Dorothee (CA); George Foti, Dollard des Ormeaux (CA)

Correspondence Address: ERICSSON RESEARCH CANADA, 8400 DECARIE BLVD., MONTREAL, QC, H4P 2N2, CA

(73) Assignee: Telefonaktiebolaget LM Ericsson (publ).

(21) Appl. No.: 09/783,814

(22) Filed: Feb. 13, 2001

(51) Int. Cl. H04Q 7/24; H04J 3/24

(52) U.S. Cl. 370/338; 370/349

(57) ABSTRACT

A hybrid Media Gateway Control Function (MGCF) implemented in a 3G wireless telecommunications network that provides access to multimedia services and IP networks for a mobile terminal operating in a circuit-switched (CS) mode. The hybrid MGCF includes a CS-specific signaling mechanism that exchanges CS-specific control signaling with a radio access network (RAN) serving the mobile terminal, and a SIP signaling mechanism that exchanges SIP control signaling with a Call State Control Function (CSCF) that accesses multimedia services for the mobile terminal. A converter in the hybrid MGCF converts the CS-specific control signaling into SIP control signaling, and sends the SIP signaling to the SIP signaling mechanism. A switching control function within the hybrid MGCF controls a Media Gateway (MGW) to route media payload from the RAN to destinations such as multimedia IP networks.

### BACKGROUND OF THE INVENTION

1. Technical Field of the Invention

This invention relates to telecommunication systems and, more particularly, to a hybrid Media Gateway Control Function (MGCF) that provides access to a packet-switched radio telecommunications network for mobile terminals operating in a circuit-switched mode.

2.Description of Related Art

Wireless networks are evolving from purely circuit-switched networks to purely Internet Protocol (IP)-based packet-switched networks. Today, wireless networks include radio base stations, Radio Network Controllers (RNCs) that control the base stations, and Mobile Switching Centers (MSCs) that perform switching functions and server functions. In future networks, as defined by current planning groups, the MSCs will be split into two parts, an MSC server for handling control signaling and a Media Gateway (MGW) for handling the media payload.

In IP-based networks, call establishment and control is performed utilizing an IP-based protocol such as the Session Initiation Protocol (SIP) developed by the Internet Engineering Task Force (IETF) or H.323 developed by the International Telecommunications Union (ITU). The IP-based signaling utilized in purely packet-switched networks must be converted to circuit-switched signaling for calls going into the Public Switched Telephone Network (PSTN). This conversion is normally performed in a Media Gateway Control Function (MGCF) or Gateway MSC (G-MSC). The signaling between the MSC server and the MGCF is typically Integrated Services User Part (ISUP) signaling. It is expected that ISUP signaling will evolve to Bearer Independent Call Control (BICC) signaling as third generation (3G) networks evolve.

To add IP technology to the wireless network, new nodes must be added such as a Serving General Packet Radio Service (GPRS) Service Node (SGSN) server. A signaling connection is provided from the RNC to the SGSN server for control, and a payload connection is provided from the RNC to an MGW. A Gateway GPRS Service Node (GGSN) together with an MGW provides access to multimedia IP networks. This infrastructure enables a mobile terminal operating in a packet-switched network to access a multimedia IP network.

In the IP portion of the wireless network, additional servers known as Call State Control Functions (CSCFs) provide access to multimedia applications and services. A CSCF may be a SIP server or an H.323 Gatekeeper, or the like. In the 3rd Generation Partnership Project (3GPP) Reference Architecture, the CSCF is a SIP server. The mobile terminal can then have access to multimedia services by sending SIP messages to the CSCF.

Thus, the wireless network includes a multimedia packet-switched domain and a circuit-switched domain, and each shares an IP infrastructure for payload transport. This provides an advantage to system operators in that they only have to maintain one transport network, the IP network, since a circuit-switched payload can be carried over the IP infrastructure. However, a serious disadvantage exists because the operators must still maintain two networks for call control and for access to applications and services. First, they have to maintain the MSC server network because the MSC servers are required to access circuit-switched applications and services. Second, they have to maintain the CSCF (SIP server) network because the CSCFs are required to access multimedia applications and services. This duplication of call control and service networks is inefficient and costly for the system operators.

One possible solution is to merely eliminate the circuit-switched portion of the access network. This requires new mobile terminals that are capable of supporting the Universal Mobile Telecommunications System (UMTS), GPRS, or the Enhanced Data Rates for GSM Evolution (EDGE) which provide packet-switched access. However, the existing base of circuit-switched mobile terminals is very large, so it is desirable to maintain the circuit-switched access capability and merge it with the packet-switched access.

In order to overcome the network inefficiencies and the disadvantages of existing solutions, it would be advantageous to have a device and network architecture that provides access to multimedia applications and services for both circuit-switched and packet-switched mobile terminals with a single server network. The present invention provides such a device integrated into a 3G wireless telecommunications network.

### SUMMARY OF THE INVENTION

In one aspect, the present invention is a hybrid Media Gateway Control Function (MGCF) in a packet-switched radio telecommunications network that provides access to multimedia services for a mobile terminal operating in a circuit-switched mode. The hybrid MGCF includes a circuit-switched (CS)-specific signaling mechanism that exchanges CS-specific control signaling with a radio access network (RAN) serving the mobile terminal, and a Session Initiation Protocol (SIP) signaling mechanism that exchanges SIP control signaling with the packet-switched radio telecommunications network. The hybrid MGCF also includes a converter that converts the CS-specific control signaling received by the CS-specific signaling mechanism into SIP control signaling, and sends the SIP signaling to the SIP signaling mechanism. A switching control function within the hybrid MGCF controls a Media Gateway (MGW) to route media payload from the RAN to a destination.

In another aspect, the present invention is a third generation (3G) wireless telecommunications network providing access to multimedia services for a mobile terminal operating in a circuit-switched mode. The network includes a RAN that provides the mobile terminal with access to the 3G network; an MGW that receives media payload from the RAN and routes the payload to a destination; and a hybrid MGCF that receives circuit-switched control signaling from the RAN and sends SIP signaling to a Call State Control Function (CSCF) that accesses multimedia services for the mobile terminal. The hybrid MGCF includes a CS-specific signaling mechanism that exchanges circuit-switched control messages with the RAN; a converter that converts the circuit-switched control messages received by the CS-specific signaling mechanism into SIP control messages; and a SIP signaling mechanism that exchanges SIP control signaling with the CSCF.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (Prior Art) is a simplified block diagram of a network reference architecture for a third generation (3G) radio telecommunications network as proposed by the 3rd Generation Partnership Project (3GPP);

FIG. 2 is a simplified block diagram of a network architecture for a radio telecommunications network in which the hybrid Media Gateway Control Function (MGCF) of the present invention has been implemented; and

FIG. 3 is a simplified block diagram of the preferred embodiment of the hybrid MGCF of the present invention.

### DETAILED DESCRIPTION OF EMBODIMENTS

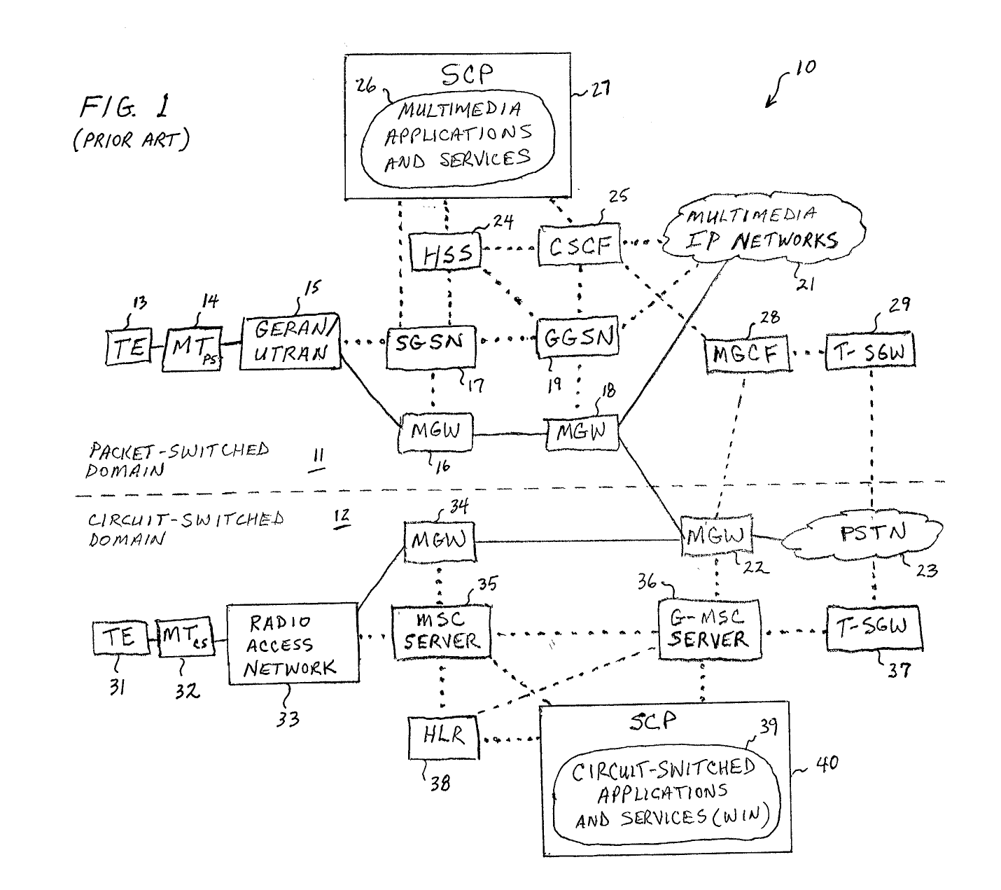

FIG. 1 is a simplified block diagram of a network architecture for a 3G radio telecommunications network 10 as proposed by the 3rd Generation Partnership Project (3GPP). Signaling paths are illustrated as dotted lines, and payload paths are illustrated as solid lines. The network is divided into a portion that exists in the packet-switched domain 11 and a portion that exists in the circuit-switched domain 12. Within the packet-switched domain, Terminal Equipment (TE) 13 may connect through a Mobile Terminal operating in the packet-switched mode (MT_{PS}) 14 to a radio access network 15 such as the GPRS Enhanced Radio Access Network (GERAN), or the Universal Mobile Telecommunications System (UMTS) Terrestrial Radio Access Network (UTRAN).

At the radio access network 15, control signaling is separated from the media payload. The payload goes to a Media Gateway (MGW) 16 associated with a Serving GPRS Service Node (SGSN) 17. The MGW is the Public Switched Telephone Network/Public Land Mobile Network (PSTN/PLMN) transport termination point for a defined network and interfaces UTRAN with the core network over an Iu interface. An MGW may terminate bearer channels from a circuit-switched network and media streams from a packet-switched network. Over the Iu interface, the MGW may support media conversion, bearer control, and payload processing for support of different Iu options for circuit-switched services. MGWs interact with MGCFs, MSC servers, and GMSC servers for resource control.

The payload then goes to a second MGW 18 associated with a Gateway GPRS Service Node (GGSN) 19. Then, depending on the destination, the payload goes either to multimedia IP networks 21 or to an MGW 22 in the circuit-switched domain for forwarding to the PSTN 23.

The control signaling goes from the radio access network 15 to the SGSN 17 and, from there, to other nodes in the core network. These nodes include a Home Subscriber Server (HSS) 24 and a Call State Control Function (CSCF) 25 through which access is made to multimedia applications and services 26 which may be resident on a Service Control Point (SCP) 27. The HSS is the master database for a given user. It contains the subscription-related information to support the network entities actually handling calls/sessions. The HSS 24 stores user identification, numbering, and addressing information; user location information at the inter-system level; user security information for authentication and authorization; and the user profile of service-related information.

The CSCF 25 consists of two components: a serving CSCF and an interrogating CSCF. The serving CSCF is used for mobile originated communications and also to support mobile terminated communications. The serving CSCF provides functionality for address handling such as analysis, translation, modification if required, address portability, and mapping of alias addresses. The serving CSCF also interacts with the HSS 24 in a user's home domain to receive profile information for network users and to notify the home domain of initial user access. The interrogating CSCF is used for mobile terminated communications and is used to determine how to route mobile terminated calls. The interrogating CSCF interrogates the HSS for information to enable the call to be directed to the serving CSCF.

The core network also includes a Media Gateway Control Function (MGCF) 28 and a Transport Signaling Gateway Function (T-SGW) 29 that exchange control signaling with entities in the circuit-switched domain. The MGCF 28 is the PSTN/PLMN termination point for a defined network. The MGCF controls the parts of the call state that pertain to connection control for media channels in the Media Gateway (MGW). The MGCF selects a CSCF depending on the routing number for incoming calls from legacy networks and communicates with the CSCF. The MGCF performs protocol conversion between the legacy call control protocols (for example, ISUP) and the 3GPP network call control protocols. The T-SGW 29 maps call-related signaling to/from the PSTN/PLMN on an IP bearer and sends it to/from the MGCF.

Within the circuit-switched domain 12, TE 31 may connect through a Mobile Terminal operating in the circuit-switched mode (MT_{CS}) 32 to a radio access network 33 such as GERAN, UTRAN, or the IS-136 RAN. Once again, at the radio access network 33, control signaling is separated from the media payload. The payload goes to an MGW 34 associated with a Mobile Switching Center (MSC) Server 35. The MSC server comprises the call control and mobility control parts of a legacy MSC. The MSC server terminates the user network signaling and translates it into the relevant network signaling. The MSC server also contains a Visitor Location Register (VLR) to store the mobile subscriber's service-related data. The MSC server controls the parts of the call state that pertain to connection control for media channels in the associated MGW 34.

The payload then goes to MGW 22 which is associated with a Gateway MSC (G-MSC) Server 36. The G-MSC Server primarily comprises the call control and mobility control parts of a legacy GMSC. From there, the payload is forwarded to the PSTN 23. A T-SGW 37 transfers control signaling between the G-MSC Server and the PSTN.

The circuit-switched network also includes a Home Location Register (HLR) 38 which serves as the master database for a given user. It contains the user profile of service-related information, and stores user identification, numbering, and location information. The HLR may be co-located with, or may other wise interface with, an Authentication Center (AC) (not shown) for authentication and authorization of MTs accessing the network.

The MSC Server 35 and the HLR 38 provide the user with access to circuit-switched applications and services such as Wireless Intelligent Network (WIN) services 39 which may be resident on an SCP 40. The system operators, therefore, must maintain the MSC Server network because the MSC Server 35 is required to access voice-related circuit-switched applications and services. The operators must also maintain the CSCF (SIP server) network because the CSCF 25 is required to access multimedia applications and services. This duplication of call control and service networks is inefficient and costly for the system operators.

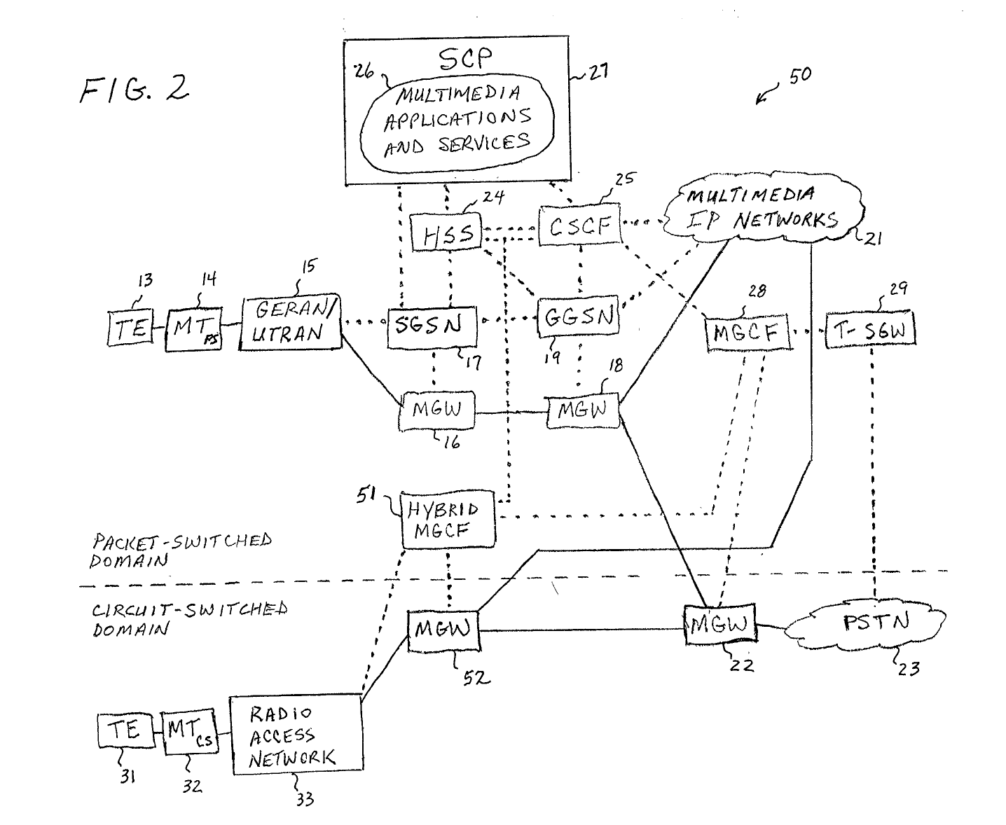

FIG. 2 is a simplified block diagram of a network architecture for a radio telecommunications network 50 in which a hybrid Media Gateway Control Function (MGCF) 51 has been implemented in order to provide legacy circuit-switched MTs with access into the 3G multimedia infrastructure. In the solution, the hybrid MGCF 51 converts circuit-switched (CS)-specific signaling into SIP signaling utilized in the core IP network, and translates SS7 signaling into IP signaling. The hybrid MGCF also utilizes control signaling such as H.248 to control an MGW 52 which controls the routing of payload information. The MGW 52 converts circuit-switched payload into packet-switched (IP) payload. In this way, the combination of the hybrid MGCF 51 and the MGW 52 acts as a SIP User Agent for circuit-switched MTs.

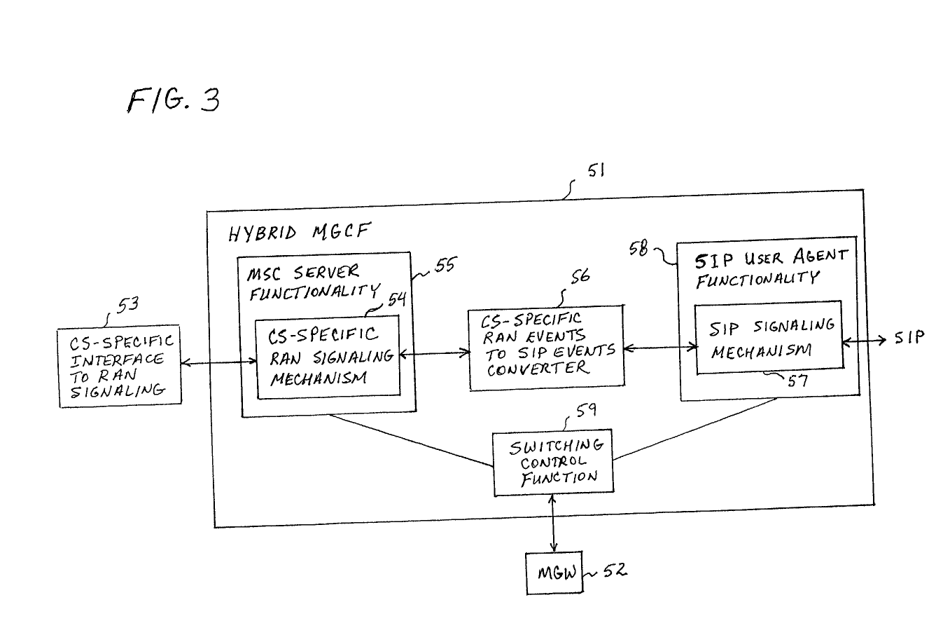

FIG. 3 is a simplified block diagram of the preferred embodiment of the hybrid MGCF 51. The hybrid MGCF essentially has a radio side and a SIP side. An interface 53 to the CS-specific part of the radio access network provides CS-specific signaling to the hybrid MGCF. The CS-specific interface 53 may be, among others for example, an A interface in a Global System for Mobile Communications (GSM) network, an Iu interface in a UMTS network, or a proprietary interface in an IS-136-based Time Division Multiple Access (TDMA) network. The Cs-specific signaling is received in the hybrid MGCF by a CS-specific RAN signaling mechanism 54 that resides within a function performing MSC Server functionality 55. Since the radio side of the hybrid MGCF mimics the behavior of an MSC server, the radio access network 33 is not impacted. The CS-specific RAN signaling mechanism passes CS-specific RAN events reported in the signaling to a converter 56 that converts the CS-specific RAN events to SIP events, and vice versa when converting in the opposite direction.

After conversion, the SIP events are passed to a SIP SIP signaling mechanism 57 within a function performing SIP User Agent functionality 58. The SIP signaling mechanism sends SIP signaling to the appropriate entities in the core IP network such as the HSS 24, the CSCF 25, and the MGCF 28. The SIP User Agent ensures that the SIP control signaling exchanged with the CSCF mimics the control signaling that the CSCF normally receives when accessing services for a mobile terminal operating in the packet-switched mode. Since the SIP side of the hybrid MGCF mimics the behavior of a SIP User Agent, it behaves as expected by the multimedia CSCF, and there is no impact on the core network. The hybrid MGCF 51 also includes a Switching Control Function 59 that utilizes control signaling such as H.248 to control the MGW 52.

Referring again to FIG. 2, when an MT_{CS} 32 accesses the circuit-switched radio access network 33 such as GERAN, UTRAN, or the IS-136 RAN, control signaling is sent to the hybrid MGCF 51, and the payload is sent to the MGW 52. The hybrid MGCF exchanges control signaling with the HSS 24, the CSCF 25, and the MGCF 28. Through this signaling, access is gained to the multimedia IP networks 21 and to the multimedia applications and services 26. The hybrid MGCF may then instruct the MGW 52 to send the payload to the multimedia IP networks 21, or to the MGW 22 for access to the PSTN 23. Since the MT_{CS} now has access to multimedia applications and services 26, which include voice-related services, the MT_{CS} no longer needs access to voice-related circuit-switched applications and services 39 (FIG. 1). Therefore, the prior art MSC Server network shown in FIG. 1 (i.e., the MSC Server 35, the G-MSC Server 36, the T-SGW 37, the HLR 38, and the circuit-switched applications and services 39) is eliminated in the network of the present invention.

In this manner, the CSCF 25 provides subscriber and/or network services to legacy circuit-switched subscribers. From the 3G network's perspective, there is no longer a need to have two different call servers, the MSC Server 35 for circuit-switched access, and the CSCF 25 for packet-switched access. Only one server, the CSCF, remains. The mobile application software in the MSC Server is no longer used to offer services for circuit-switched subscribers. The only software remain active in the MSC Server functionality 55 is the radio handling part for legacy base stations.

The present invention provides a credible and feasible implementation to provide hooks for 2G to 3G migration for system operators. It provides a smooth migration into 3G since operators can selectively connect new sites to the CSCF and can understand the impacts on the network as a whole. As a side effect of moving the handling of network/subscriber services and mobile functionality to the CSCF 25, there is a significant reduction in the processor load on the legacy (circuit-switched) MSCs (not shown). Hence, more base stations can be connected to those MSCs, or some of the MSCs can be eliminated. The present invention also provides circuit-switched subscribers with access to potentially enhanced 2G services since the processing for those subscribers is handled in the CSFC where the services are enhanced for multimedia.

It should be noted that base stations configured as Enhanced Data Rates for GSM Evolution (EDGE) base stations are connected to the SGSN 17 through a Radio Network Controller (RNC). In the network of the present invention, when an EDGE (packet-switched) MT sends a SIP Invite message, the message is routed to the CSCF 25, transparent to the rest of the SGSN/GGSN infrastructure. The SGSN 17, the GGSN 19, etc. do not know what the message is since it is an IP packet. The CSCF opens the packet and determines that it is a SIP Invite message. The session is then established and services are offered to the EDGE MT.

The invention enables legacy (circuit-switched) MTs to access the same CSCF infrastructure since the hybrid MGCF 51 is connected to the radio access network 33 for control, and the associated MGW 52 is connected to the radio access network for payload. When a legacy MT wants to make a call, it sends an origination message which is routed to the hybrid MGCF. The hybrid MGCF receives the message like an MSC server, and translates the message into a SIP Invite message. The SIP Invite message is then sent to the CSCF 25 and the session is then established and services are offered to the legacy MT.

While the requests for session establishment coming from EDGE MTs may request either a single flow for voice or multiple flows for multimedia sessions, the requests from the legacy MTs are, of course, limited to a single flow, namely voice.

It is thus believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims.

What is claimed is:

1. A hybrid Media Gateway Control Function (MGCF) in a packet-switched radio telecommunications network that provides access to multimedia services for a mobile terminal operating in a circuit-switched mode, said hybrid MGCF comprising:
a circuit-switched (CS)-specific signaling mechanism that exchanges CS-specific control signaling with a radio access network serving the mobile terminal;
a Session Initiation Protocol (SIP) signaling mechanism that exchanges SIP control signaling with the packet-switched radio telecommunications network;
a converter that converts the CS-specific control signaling received by the CS-specific signaling mechanism into SIP control signaling, and sends the SIP signaling to the SIP signaling mechanism; and
a switching control function that controls a Media Gateway (MGW) to route media payload from the radio access network to a destination.

2. The hybrid MGCF of claim 1 wherein the CS-specific signaling mechanism is associated with a Mobile Switching Center (MSC) Server functionality function within the hybrid MGCF that mimics MSC Server functionality.

3. The hybrid MGCF of claim 2 wherein the MSC Server functionality function includes a radio handling part for legacy base stations.

4. The hybrid MGCF of claim 2 wherein the SIP signaling mechanism is associated with a SIP User Agent functionality function within the hybrid MGCF that mimics SIP User Agent functionality.

5. The hybrid MGCF of claim 4 wherein the converter converts radio access network events reported to the hybrid MGCF in CS-specific signaling messages into SIP events in SIP signaling messages.

6. The hybrid MGCF of claim 5 wherein the SIP signaling mechanism exchanges SIP control signaling with a Call State Control Function (CSCF) that accesses multimedia services for the mobile terminal.

7. The hybrid MGCF of claim 6 wherein the SIP User Agent ensures that the SIP control signaling exchanged with the CSCF mimics the control signaling that the CSCF normally receives when accessing services for a mobile terminal operating in the packet-switched mode.

8. The hybrid MGCF of claim 5 wherein the switching control function controls the MGW to route media payload from the radio access network to a multimedia Internet Protocol (IP) network.

9. A third generation (3G) wireless telecommunications network providing access to multimedia services to a mobile terminal operating in a circuit-switched mode, said network comprising:
a radio access network (RAN) that provides the mobile terminal with access to the 3G network;
a Media Gateway (MGW) that receives media payload from the RAN and routes the payload to a destination;
a Call State Control Function (CSCF) that accesses multimedia services for the mobile terminal; and
a hybrid Media Gateway Control Function (MGCF) that comprises:
a circuit-switched (CS)-specific signaling mechanism that exchanges circuit-switched control messages with the RAN;
a converter that converts the circuit-switched control messages received by the CS-specific signaling mechanism into Session Initiation Protocol (SIP) control messages; and
a SIP signaling mechanism that exchanges SIP control signaling with the CSCF.

10. The 3G wireless telecommunications network of claim 9 wherein the hybrid MGCF also includes a Mobile Switching Center (MSC) Server functionality function that mimics MSC Server functionality.

11. The 3G wireless telecommunications network of claim 10 wherein the RAN includes a plurality of legacy base stations, and the MSC Server functionality function includes a radio handling part for the legacy base stations.

12. The 3G wireless telecommunications network of claim 10 wherein the hybrid MGCF also includes a SIP User Agent functionality function that mimics SIP User Agent functionality.

13. The 3G wireless telecommunications network of claim 12 wherein the converter within the hybrid MGCF converts radio access network events reported to the hybrid MGCF in CS-specific signaling messages into SIP events in SIP signaling messages.

14. The 3G wireless telecommunications network of claim 13 wherein the SIP signaling mechanism within the hybrid MGCF exchanges SIP control signaling with a Call State Control Function (CSCF) that accesses multimedia services for the mobile terminal.

15. The 3G wireless telecommunications network of claim 14 wherein the SIP User Agent within the hybrid MGCF ensures that the SIP control signaling exchanged with the CSCF mimics the control signaling that the CSCF normally receives when accessing services for a mobile terminal operating in the packet-switched mode.

16. The 3G wireless telecommunications network of claim 15 wherein the switching control function within the hybrid MGCF controls the MGW to route media payload from the radio access network to a multimedia Internet Protocol (IP) network.
